(19) United States
(12) Patent Application Publication
(10) Pub. No.: US 2008/0178845 A1
(43) Pub. Date: Jul. 31, 2008

(54) FUEL INJECTION PUMP

(75) Inventor: Hiroyuki SHIMAI, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-shi (JP)

(21) Appl. No.: 12/015,053

(22) Filed: Jan. 16, 2008

(30) Foreign Application Priority Data
Jan. 31, 2007 (JP) 2007-21378
Nov. 21, 2007 (JP) 2007-301985

(51) Int. Cl. F02M 59/44

(52) U.S. Cl. 123/446

(57) ABSTRACT

A fuel injection pump includes a pump housing, which has a cam chamber accommodating an eccentric cam of a camshaft, a plunger pump portion, which includes a plunger driven by the eccentric cam, and a feed pump driven by the camshaft for supplying fuel to the plunger pump portion. The camshaft has one end inserted in a through hole of an outer wall of the pump housing. A cover is fixed to the outer wall of the pump housing to close the through hole. The cover is coupled with a first pressure regulating valve for regulating pressure of fuel discharged from the feed pump. The longitudinal direction of the first pressure regulating valve is at a predetermined angle with respect to the longitudinal direction of the camshaft.

### CROSS REFERENCE TO RELATED APPLICATIONS

This application is based on and incorporates herein by reference Japanese Patent Applications No. 2007-21378 filed on Jan. 31, 2007 and No. 2007-301985 filed on Nov. 21, 2007.

### FIELD OF THE INVENTION

The present invention relates to a fuel injection pump provided with a feed pump and a pressure regulating valve.

### BACKGROUND OF THE INVENTION

For example, U.S. Pat. No. 6,289,875 B1 (JP-A-2000-240531) discloses a fuel injection pump for a diesel engine. As shown in FIG. 8, in general, a fuel injection pump is provided with a high-pressure pump portion (plunger pump portion) 120 and a feed pump 140 as a low-pressure pump portion. The high-pressure pump portion 120 is driven by a camshaft 100 to compress fuel and supply the compressed fuel to a common rail 110. The low-pressure pump portion (feed pump 140) pumps fuel from a fuel tank 130 to the high-pressure pump portion 120.

A regulator valve 150 is provided for regulating pressure of fuel discharged from the feed pump 140 and to be supplied to the high-pressure pump portion 120. Specifically, when pressure of fuel increases to a threshold, the regulator valve 150 opens to recirculate the fuel from the downstream of the feed pump 140 to the upstream of the feed pump 140. The regulator valve 150 is inserted in a mount hole provided in a pump housing 160, thereby being mounted in the pump housing 160.

In FIG. 8, the feed pump 140, the regulator valve 150, and the like are depicted perpendicularly to the camshaft 100. In such a fuel injection pump, the pump housing 160 has a constraint of space for accommodating the regulator valve 150. Specifically, as shown in FIG. 8, the pump housing 160 is provided with an inlet metering valve 170 for controlling quantity of fuel supplied to the high-pressure pump portion 120, in addition to being provided with the regulator valve 150. Furthermore, the pump housing 160 has multiple fuel passages 180 therein. Accordingly, flexibility of layout of components and passages in the pump housing 160 is small, and manufacturing of the pump housing 160 is also difficult.

### SUMMARY OF THE INVENTION

In view of the foregoing and other problems, it is an object of the present invention to produce a fuel injection pump provided with a regulator valve being facilitated in layout thereof.

According to one aspect of the present invention, a fuel injection pump for an engine, the fuel injection pump comprises a pump housing having one side and an other side therebetween having a cam chamber, the one side and the other side respectively having one through hole and an other through hole. The fuel injection pump further comprises a camshaft having an eccentric cam accommodated in the cam chamber, the camshaft having one end inserted in the one through hole, the camshaft having an other end inserted in the other through hole, the one end adapted to being transmitted with output power of the engine. The fuel injection pump further comprises a plunger pump portion including a plunger movable inside a cylinder for pumping fuel in conjunction with a rotary motion of the eccentric cam. The fuel injection pump further comprises a feed pump for supplying fuel to the plunger pump portion by being driven by the camshaft. The fuel injection pump further comprises a first pressure regulating valve for regulating pressure of fuel discharged from the feed pump. The fuel injection pump further comprises a cover fixed to an outer wall of the other side of the pump housing to close the other through hole. The cover is coupled with the first pressure regulating valve such that a longitudinal direction of the first pressure regulating valve is at a predetermined angle with respect to a longitudinal direction of the camshaft.

According to another aspect of the present invention, a fuel injection pump comprises a pump housing having a cam chamber. The fuel injection pump further comprises a camshaft having an eccentric cam accommodated in the cam chamber, the camshaft having an axial end inserted in a through hole of an outer wall of the pump housing. The fuel injection pump further comprises a plunger pump portion including a plunger for pumping fuel by being driven by the eccentric cam. The fuel injection pump further comprises a feed pump for supplying fuel to the plunger pump portion by being driven by the camshaft. The fuel injection pump further comprises a pressure regulating valve for regulating pressure of fuel discharged from the feed pump. The feed pump is separately provided from the pump housing and fixed to the outer wall to close the through hole. The pressure regulating valve is coupled with the feed pump such that a longitudinal direction of the pressure regulating valve is inclined with respect to a longitudinal direction of the camshaft.

### BRIEF DESCRIPTION OF THE DRAWINGS

The above and other objects, features and advantages of the present invention will become more apparent from the following detailed description made with reference to the accompanying drawings, In the drawings:

FIG. 1A is a front view showing a pump unit, FIG. 1B is a plan view showing the pump unit when being viewed along an axis of a fuel injection pump provided with the pump unit, and FIG. 1C is a side view showing the pump unit, according to a first embodiment;

FIG. 2 is a schematic view showing an accumulator fuel injection system provided with the fuel injection pump;

FIG. 3 is a sectional view showing the fuel injection pump;

FIG. 4A is a side view showing a hollow screw having a fuel outlet hole of the fuel injection pump, and FIG. 4B is a side view showing a pipe member having the fuel outlet hole;

FIG. 5A is a front view showing a pump unit, and FIG. 5B is a plan view showing the pump unit when being viewed along the axis of the fuel injection pump provided with the pump unit, according to a second embodiment;

FIG. 6A is a front view showing a pump unit, and FIG. 6B is a plan view showing the pump unit when being viewed along the axis of the fuel injection pump provided with the pump unit, according to a third embodiment;

FIG. 7 is a plan view showing a fuel injection pump when being viewed along the axis of the fuel injection pump, according to a fourth embodiment; and

FIG. 8 is a schematic view showing a fuel injection pump according to a related art.

### DETAILED DESCRIPTION OF PREFERRED EMBODIMENTS

### First Embodiment

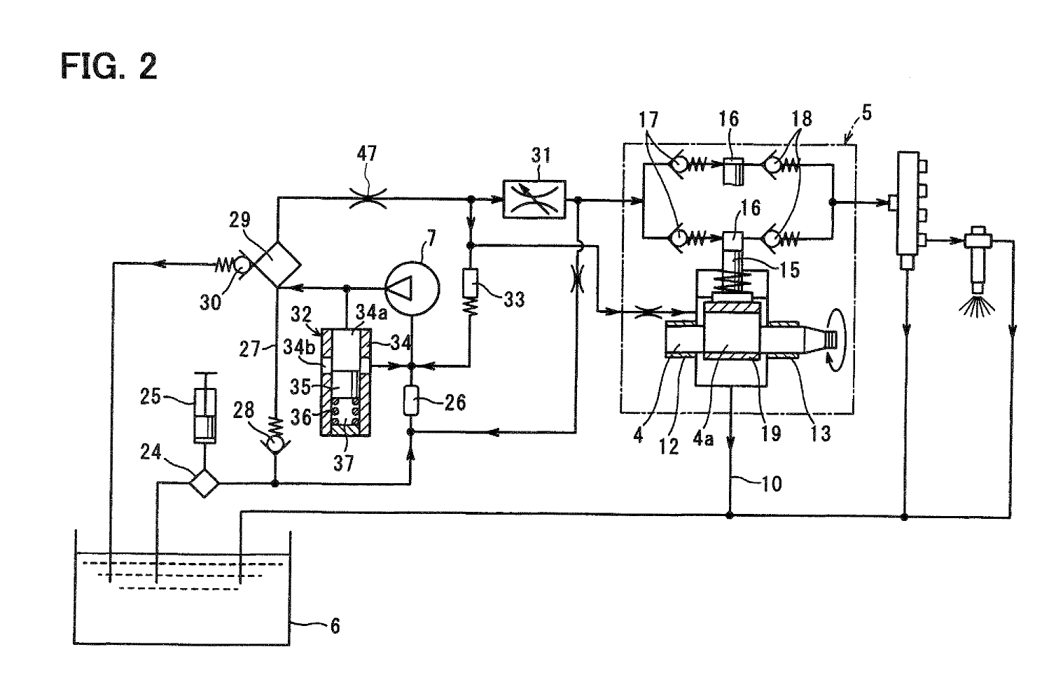

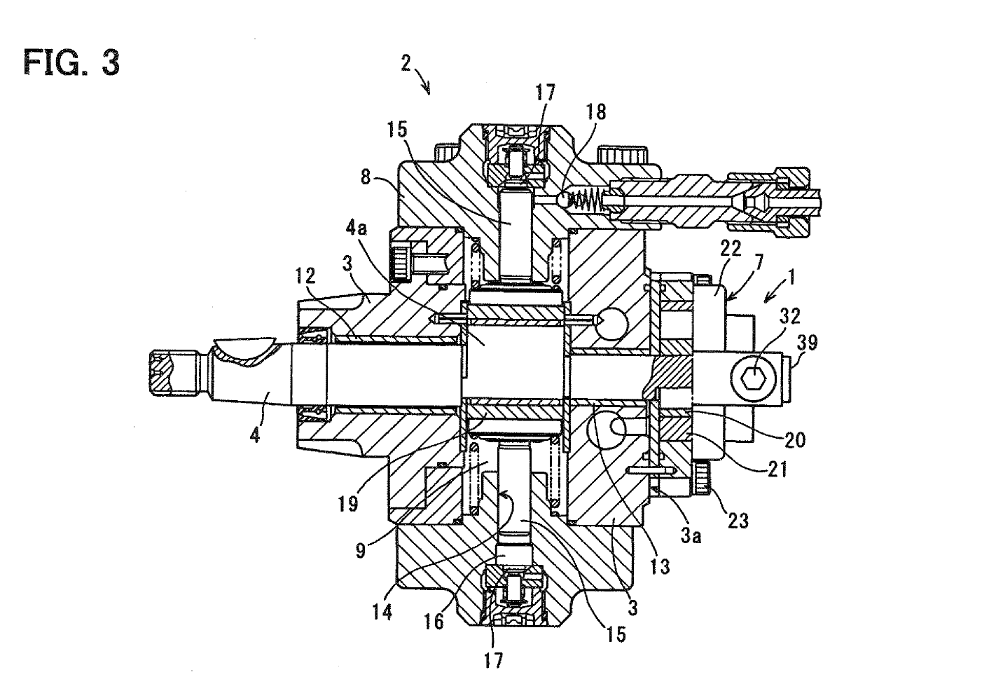

As shown in FIG. 2, in the present embodiment, a fuel injection pump 2 includes a camshaft 4, pump housings 3, a high-pressure pump portion (plunger pump portion) 5, a feed pump 7, and fuel regulating means. The camshaft 4 is rotatably supported by the pump housings 3 (FIG. 3). The high-pressure pump portion 5 drives the camshaft 4 to pressurize and feed fuel. The feed pump 7 pumps fuel from a fuel tank 6 to supply the fuel to the high-pressure pump portion 5. The fuel regulating means regulates pressure of fuel discharged from the feed pump 7.

As shown in FIG. 3, the pump housings 3 and a cylinder head 8 therebetween define a cam chamber 9 filled with lubricating oil (fuel). The pump housings 3 respectively have through holes each being inserted with the camshaft 4. One of the through holes is located on one side of the cam chamber 9. The other of the through holes is located on the other side of the cam chamber 9. Fuel discharged from the feed pump 7 is partially supplied to the cam chamber 91 as lubricating oil. Fuel overflowing from the cam chamber 9 returns to the fuel tank 6 through an overflow pipe 10 (FIG. 2).

The camshaft 4 is provided with an eccentric cam 4a, which is located in the cam chamber 9. One end of the camshaft 4 on the left side in FIG. 3 is inserted into the through hole of the pump housing 3 on the one side and supported via a bush 12. The other end of the camshaft 4 on the right side in FIG. 3 is inserted into the through hole of the pump housing 3 on the other side and supported via a bush 13. The camshaft 4 has one end, which projects through the one through hole of the pump housing 3. The camshaft 4 is transmitted with output power of a diesel engine at the one end, so that the camshaft 4 is rotated.

The high-pressure pump portion 5 has cylinders 14 respectively formed in the cylinder heads 8. The high-pressure pump portion 5 includes plungers 15 respectively inserted in the cylinders 14, and movable in the cylinders 14. The plungers 15 axially move inside the cylinders 14 in response to rotation of the eccentric cam 4a, thereby drawing fuel, and pressurizing and feeding the fuel.

The cylinder heads 8 respectively have compression chambers 16 each having a volume, which increases and decreases in response to the movement of each plunger 15 in each cylinder 14. Each of the compression chambers 16 is provided with a suction valve 17 and a discharge valve 18. The suction valve 17 opens when the compression chamber 16 draws fuel to the compression chamber 16. The discharge valve 18 opens when the fuel is discharged from the compression chamber 16. Rotary motion of the eccentric cam 4a is changed into straight-line motion by a cam ring 19, so that the plunger 15 reciprocates inside the cylinder 14 in response to the straight-line motion.

As shown in FIG. 3, the feed pump 7 is a well-known trochoid pump, for example. The feed pump 7 includes a pump element and a pump case 22. The pump element includes an inner rotor 20 and an outer rotor 21. The pump case 22 accommodates the pump element. The pump case 22 is fixed to an outer wall 3a of the pump housing 3 with bolts 23. The pump case 22 as a cover is fixed to the outer wall 3a of the pump housing 3 on the other side of the pump housing 3 to close an opening of a through hole passing through the pump housing 3.

As shown in FIG. 2, a prefilter 24, a priming pump 25, and a gauze filter 26 provided upstream of the feed pump 7. The prefilter 24 filters fuel pumped from the fuel tank 6. The priming pump 25 is used for air vent from a pipe at the time of assembly of a vehicle, for example. The gauze filter 26 is provided for removing a foreign matter contained in fuel in a pipe downstream of the prefilter 24.

A bypass passage 27 is provided to a passage between the prefilter 24 and the gauze filter 26 for leading fuel pumped using the priming pump 25 to the downstream of the feed pump 7. A check valve 28 is provided in the bypass passage 27 to restrict counterflow of fuel.

A fuel filter 29 and a safety relief valve 30 are provided downstream of the feed pump 7. The fuel filter 29 filters fuel discharged from the feed pump 7. The safety relief valve 30 is used for air vent. Each of the prefilter 24 and the gauze filter 26 is formed of, for example, a metal mesh having a relatively coarse mesh. The fuel filter 29 excels in filtration performance compared with the prefilter 24 and the gauze filter 26, thereby capable of a small foreign matter, moisture, and the like, which cannot be removed with the prefilter 24 and the gauze filter 26.

The fuel filter 29 is provided outside the fuel injection pump 2, and is connected with the fuel injection pump 2 via a fuel pipe. In the present structure, fuel discharged from the feed pump 7 is once lead outside the fuel injection pump 2, and supplied to the fuel filter 29. The fuel is filtered through the fuel filter 29, and lead inside the fuel injection pump 2. The safety relief valve 30 is, for example, a check valve opened in response to discharge pressure of the feed pump 7, thereby discharging air drawn into the pipe together with fuel.

Fuel is taken inside the fuel injection pump 2 after being filtered through the fuel filter 29. The fuel is supplied to the high-pressure pump portion 5 after passing through an inlet metering valve 31 attached inside the pump housing 3. The inlet metering valve 31 is an electromagnetic valve for metering quantity of fuel supplied to the high-pressure pump portion 5. The inlet metering valve 31 is controlled in valve-opening area based on, for example, the operating condition of the diesel engine. Fuel regulating means includes a first fuel pressure regulating valve 32 and a second fuel pressure regulating valve 33.

The first fuel pressure regulating valve 32 regulates pressure (discharge pressure) of fuel discharged from the feed pump 7, such that fuel pressure exerted to the fuel filter 29 does not exceed a pressure capacity of the fuel filter 29. The first fuel pressure regulating valve 32 is built into the pump case 22 of the feed pump 7, thereby being constructed to one component of a pump unit 1 together with the feed pump 7.

The second fuel pressure regulating valve 33 is capable of regulating pressure of fuel supplied to the high-pressure pump portion 5. The second fuel pressure regulating valve 33 is provided in the pump housing 3.

An orifice 47 (FIG. 2) is provided in a fuel passage, which communicates the first fuel pressure regulating valve 32 with the second fuel pressure regulating valve 33. The orifice 47 throttles downstream of the fuel filter 29. In the present structure, the first fuel pressure regulating valve 32 regulates pressure of fuel upstream of the orifice 47.

As follows, the structure of the pump unit 1 is described.

As shown in FIG. 2, the first fuel pressure regulating valve 32 includes a valve body 34, a piston 35, and a spring 36. The valve body 34 is substantially a cylindrical member. The piston 35 and the spring 36 are accommodated in the valve body 34. The valve body 34 has an inlet hole 34a and a relief hole 34b. The inlet hole 34a communicates with an outlet of the feed pump 7. The relief hole 34b communicates with an inlet of the feed pump 7.

Discharge pressure of the feed pump 7 is applied to the front surface of the piston 35. Counterforce of the spring 36 and pressure in a damper chamber 37 on the opposite side to the inlet hole of the piston 35 are exerted to the rear surface of the piston 35. The piston 35 is displaced at a position in which the discharge pressure applied to the front surface of the piston 35 and the force exerted to the rear surface of the piston 35 balance, thereby controlling an opening area of the relief hole 34b. Fuel flowing out of the relief hole 34b returns to the inlet of the feed pump 7.

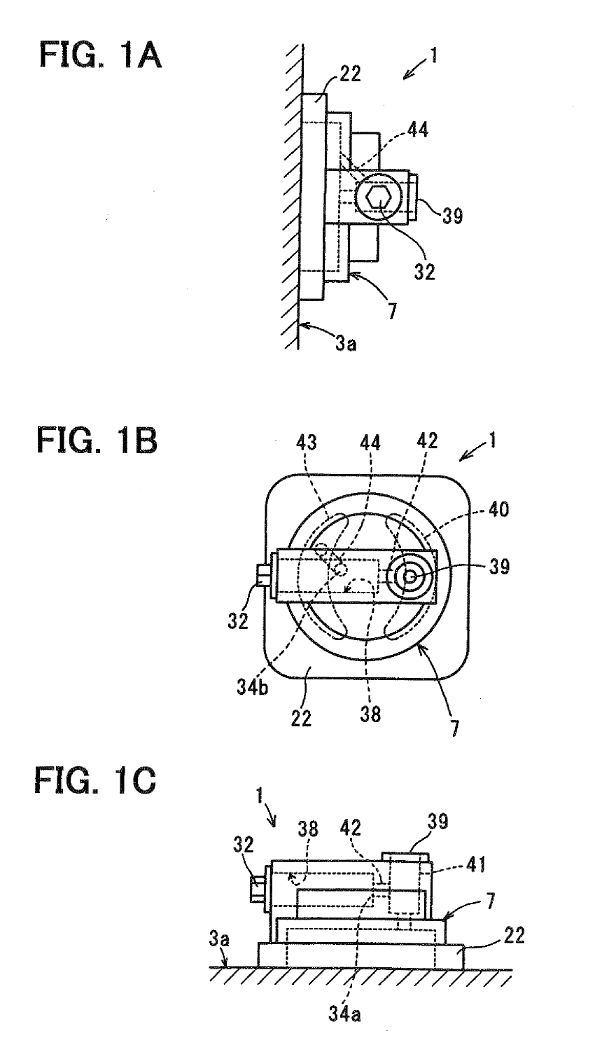

As shown in FIGS. 1A to 1C, the first fuel pressure regulating valve 32 is attached to the pump case 22 such that the valve body 34 of the first fuel pressure regulating valve 32 is inserted into a mount hole 38 of the pump case 22 of the feed pump 7. In the present structure, the pump unit 1 is constructed of the feed pump 7 and the first fuel pressure regulating valve 32.

As shown in FIG. 1C, the mount hole 38 is perforated in a backside of the pump element on the opposite side of the pump housing 3. The mount hole 38 is perpendicular to the axis of the fuel injection pump 2. That is, the mount hole 38 is perpendicular to the vertical direction of FIG. 1C, and is in parallel with the horizontal direction of FIG. 1C. In the present structure, the first fuel pressure regulating valve 32 is perpendicular to a movable direction of the piston 35 in a condition where the valve body 34 is inserted in the mount hole 38. That is, the longitudinal direction of the first fuel pressure regulating valve 32 is perpendicular to the axial direction of the piston 35 when the valve body 34 is inserted in the mount hole 38. The first fuel pressure regulating valve 32 is in parallel with the outer wall 3a of the pump housing 3 to which the feed pump 7 is fixed.

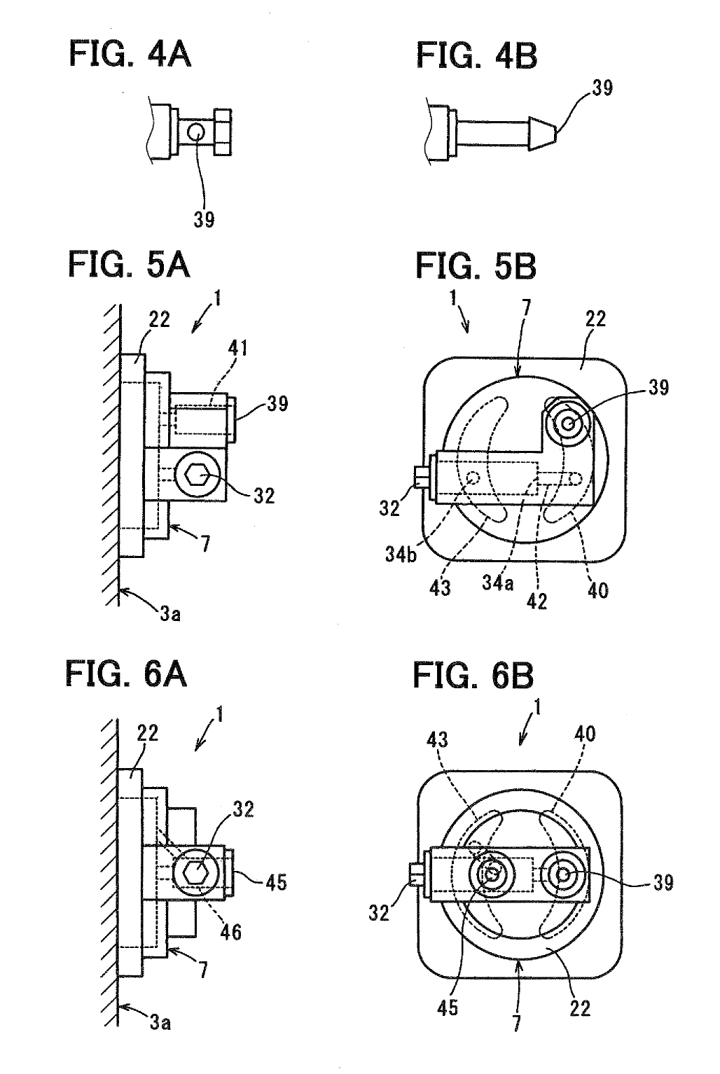

As shown in FIG. 1, the pump case 22 has a fuel outlet hole 39 for discharging fuel, which is pressurized in the pump element. The fuel outlet hole 39 is connected with an inlet hole of the fuel filter 29 (FIG. 2) through an external fuel pipe. The fuel outlet hole 39 may be provided with a hollow screw shown in FIG. 4A or a pipe member shown in FIG. 4B. The pump case 22 has a discharge passage 41 (FIG. 1C), an introduction passage 42 (FIGS. 4B, 4C), and a relief passage 44 (FIGS. 4A, 4B). The discharge passage 41 (FIG. 1C) communicates an outlet port 40, which is provided in the outlet of the pump element, with the fuel outlet hole 39. The introduction passage 42 (FIGS. 4B, 4C) communicates the discharge passage 41 with the inlet hole 34a, which is provided in the valve body 34 of the first fuel pressure regulating valve 32. The relief passage 44 (FIGS. 4A, 4B) communicates an inlet port 43, which is provided in the inlet of the pump element, with the relief hole 34b, which is provided in the valve body 34 of the first fuel pressure regulating valve 32.

(Operation)

In the present embodiment, the first fuel pressure regulating valve 32 is attached to the pump case 22. The valve body 34 of the first fuel pressure regulating valve 32 is inserted into the mount hole 38 of the pump case 22 of the feed pump 7. In the present structure, the pump unit 1 is constructed of the feed pump 7 and the first fuel pressure regulating valve 32. In the present structure, the first fuel pressure regulating valve 32 is not provided inside the pump housing 3, which has constraints of layout, i.e. arrangement of components, but provided to the pump case 22 of the feed pump 7 fixed to the outer wall 3a of the pump housing 3. Therefore, a mount space for the first fuel pressure regulating valve 32 can be easily secured.

In the present structure, the pump housing 3 need not be provided with a mount hole for receiving the first fuel pressure regulating valve 32. Therefore, flexibility of layout of the inlet metering valve 31, which is attached to the pump housing 3, can be enhanced. Furthermore, flexibility of layout of the multiple fuel passages in the pump housing 3 can be enhanced. For example, the passage for supplying fuel from the feed pump 7 to the high-pressure pump portion 5 through the inlet metering valve 31 and the passage for supplying fuel from the feed pump 7 to the cam chamber can be further arbitrary arranged in the pump housing 3.

In addition, the first fuel pressure regulating valve 32 is arranged such that the longitudinal direction, i.e. movable direction of the first fuel pressure regulating valve 32 is substantially at right angle with respect to the axial direction of the fuel injection pump 2. The first fuel pressure regulating valve 32 is located along the outer wall 3a of the pump housing 3. Therefore, the fuel injection pump 2 can be restricted from increasing in volume with respect to the axial direction, even in the structure where the pump case 22 is mounted with the first fuel pressure regulating valve 32.

In the present embodiment, the valve body 34 of the first fuel pressure regulating valve 32 is inserted into the mount hole 38 of the pump case 22. In the present structure, the fuel passage, which communicates the feed pump 7 with the first fuel pressure regulating valve 32, can be readily provided in the pump case 22. Specifically, the introduction passage 42 can be readily provided in the pump case 22 to communicate the discharge passage 41 of the feed pump 7 with the inlet hole 34a of the valve body 34. In addition, the relief passage 44 can be readily provided in the pump case 22 to communicate the inlet port 43 of the feed pump 7 with the relief hole 34b of the valve body 34. In the present structure, the first fuel pressure regulating valve 32 can be efficiently laid out.

Furthermore, a space margin is produced in the pump housing 3, by providing the first fuel pressure regulating valve 32 in the pump case 22 of the feed pump 7. Therefore, an additional element can be provided in the pump housing 3. In the present embodiment, the second fuel pressure regulating valve 33 as an additional element can be provided in the pump housing 3.

In the present structure, the feed pump 7 is secured to the outer wall 3a of the pump housing 3 of the fuel injection pump 2. Therefore, the first fuel pressure regulating valve 32 can be mounted to the feed pump 7 using the pump case 22.

In the present structure, the pump case 22 has the mount hole 38 on the opposite side of the pump housing 3 with respect to the pump element in the axial direction of the pump element. The mount hole 38 is adapted to accommodating the first pressure regulating valve 32. The first pressure regulating valve 32 includes the valve element 35 and the valve body 34. The valve body 34 is mounted to the pump case 22 in a condition where the valve body 34 is inserted in the mount hole 38. In the present structure, the first fuel pressure regulating valve 32 is inserted into the pump case 22 to construct a pump unit. Thus, fuel passage can be readily formed between the first fuel pressure regulating valve 32 and the pump case 22.

In the present structure, the pump case 22 has the fuel outlet hole 39, and a part of the passages of the feed pump 7 and the first fuel pressure regulating valve 32 can be shared. Thus, layout of the components and passages can be flexibly and efficiently determined.

The pump case 22 may have a fuel inlet hole for drawing fuel from the fuel tank 6 into the pump case 22. In this case, a part of the passages can be also shared between the feed pump 7 and the first fuel pressure regulating valve 32, so that layout of the components and passages can be flexibly and efficiently determined.

### Second Embodiment

In the first embodiment, the introduction passage 42 is branched out from the discharge passage 41, which communicates the outlet port 40 of the feed pump 7 with the fuel outlet hole 39, such that the introduction passage 42 communicates the inlet hole 34a with the valve body 34. That is, a part of the fuel passage is shared in the first embodiment. In contrast, in the present embodiment shown in FIGS. 5A, 5B, the discharge passage 41, which communicates the outlet port 40 with the fuel outlet hole 39, and the introduction passage 42, which communicates the outlet port 40 with the inlet hole 34a, are isolated from each other.

In the present embodiment, the feed pump 7 is also capable of producing an effect similarly to the first embodiment. In addition, the first fuel pressure regulating valve 32 can be efficiently laid out.

### Third Embodiment

In the present embodiment shown in FIGS. 6A, 6B, the pump case 22 of the pump unit 1 has both the fuel outlet hole 39 and a fuel inlet hole 45.

The fuel outlet hole 39 is provided with a fuel pipe to connect the fuel outlet hole 39 with the fuel filter 29, similarly to the first embodiment. The fuel inlet hole 45 is provided with a fuel pipe, which communicates the fuel inlet hole 45 with the fuel tank 6. Fuel is pumped from the fuel tank 6 through the present fuel pipe, and the fuel flows into the inlet port 43 through the fuel inlet hole 45.

In the first embodiment, the pump case 22 has the relief passage 44, which communicates the inlet port 43 of the feed pump 7 with the relief hole 34b of the valve body 34. In contrast, in the present embodiment shown in FIG. 6A, the pump case 22 has an inlet passage 46, which communicates the fuel inlet hole 45 with the inlet port 43. The inlet passage 46 further communicates with the relief hole 34b through the relief passage 44.

In the present structure, the pump unit 1 can be isolated from the fuel injection pump 2 by providing both the fuel outlet hole 39 and the fuel inlet hole 45 in the pump case 22. When a fuel injection system does not need the feed pump 7, the pump unit 1 may be omitted from the pump housing 3. Thus, a fuel injection pump 2 including only the high-pressure pump portion 5 can be readily manufactured.

The fuel inlet hole 45 may be provided with a hollow screw shown in FIG. 4A or a pipe member shown in FIG. 4B, similarly to the fuel outlet hole 39.

### Fourth Embodiment

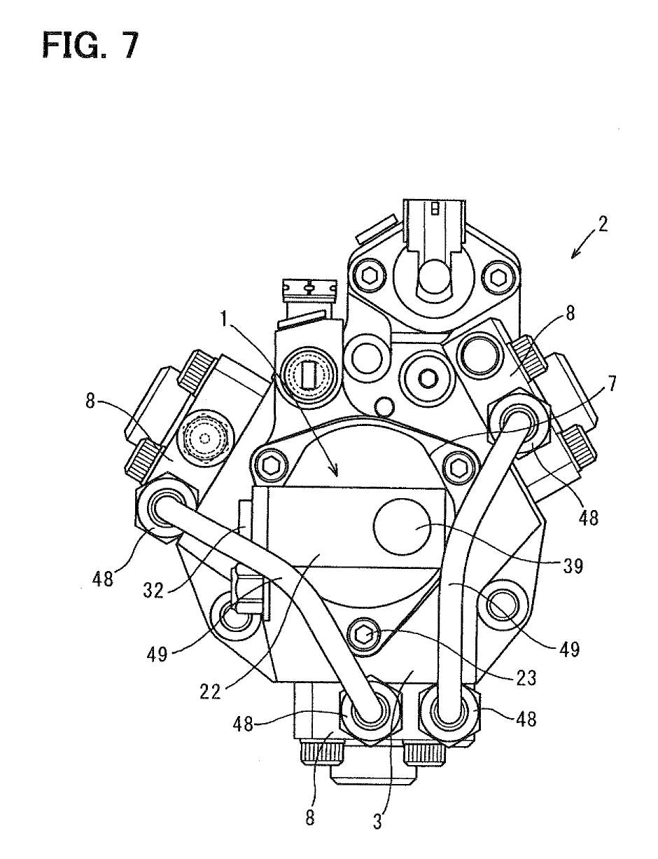

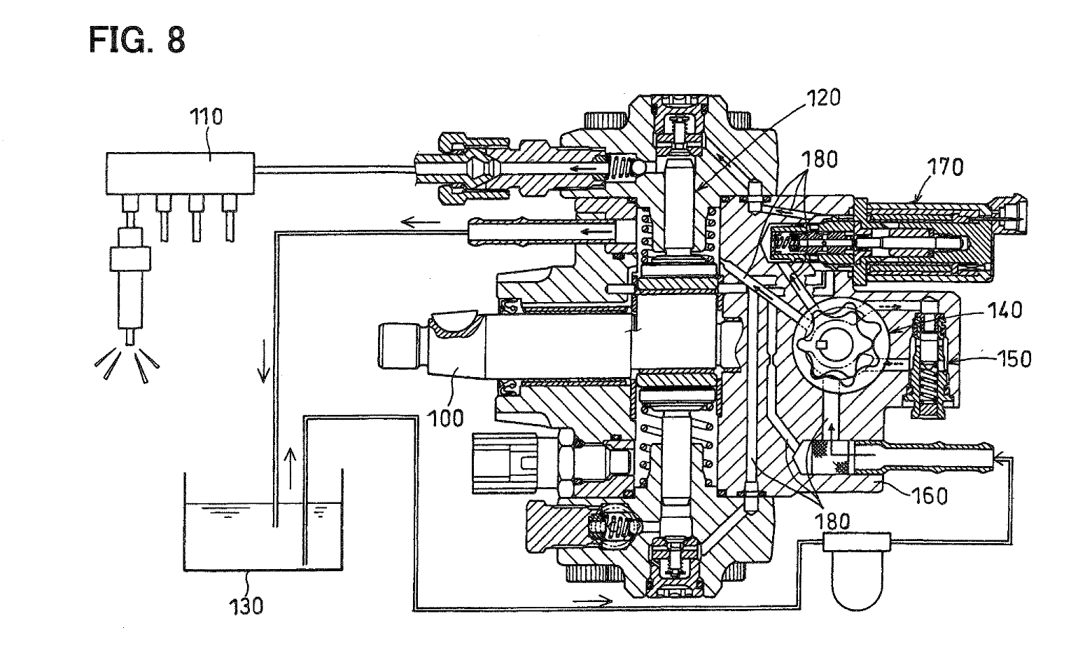

In the present embodiment, the fuel outlet hole 39 of the pump case 22 extends substantially in parallel with the longitudinal direction of the camshaft 4 (FIG. 3). That is, the fuel outlet hole 39 extends substantially perpendicular to the paper surface of FIG. 7.

In the present embodiment shown in FIG. 7, the fuel injection pump 2 is a three-cylinder engine having three cylinder heads 8. The three cylinder heads 8 are provided at intervals of substantially 120 degree relative to the pump housing 3. Each cylinder head 8 is connected with two fuel pipes 49 via a connection member 48.

The pump unit 1 includes the feed pump 7 and the first fuel pressure regulating valve 32. The pump case 22 of the feed pump 7 is fixed to the outer wall 3a of the pump housing 3 with the bolts 23, similarly to the first embodiment.

The pump case 22 has the fuel outlet hole 39 for discharging fuel, which is pressurized in the feed pump 7. The fuel outlet hole 39 extends substantially along the longitudinal direction of the camshaft 4. The fuel inlet hole 45 (FIG. 6) may extend substantially along the longitudinal direction of the camshaft 4, similarly to the fuel outlet hole 39.

In the present structure, a fuel pipe (not shown) of the vehicle to be connected with the fuel outlet hole 39 can be restricted from interfering with the two fuel pipes 49. Furthermore, the fuel pipe of the vehicle may not interfere with a component of the vehicle such as an engine block close to the lateral side of the fuel injection pump 2. Therefore, connection of the fuel pipe of the vehicle with fuel outlet hole 39 can be facilitated, so that the fuel pipe can be readily handled.

(Modification)

In the first embodiment, the longitudinal direction, i.e., the movable direction of the piston 35 of the first fuel pressure regulating valve 32 is substantially perpendicular to the axial direction of the fuel injection pump 2. The piston 35 is not limited to being oriented in the manner of the first embodiment. It suffices that the longitudinal direction of the first fuel pressure regulating valve 32 is at an angle relative to the axial direction of the fuel injection pump 2. That is, it suffices that the longitudinal direction of the first fuel pressure regulating valve 32 is inclined relative to the axial direction of the fuel injection pump 2.

In the first to third embodiments, the pump case 22 has the fuel outlet hole 39. Alternatively, the fuel outlet hole 39 may be omitted, and only the fuel inlet hole 45 described in the third embodiment may be provided in the pump case 22. Both the fuel outlet hole 39 and the fuel inlet hole 45 may be omitted from the pump case 22.

In the first embodiment of the fuel injection pump 2, the pump housing 3 has the through hole, and the through hole is blocked with the pump case 22 of the feed pump 7 on the other side. Alternatively, the through hole of the pump housing 3 may be blocked with a component such as a cover, other than the pump case 22. In this case, the component can be provided with the first fuel pressure regulating valve 32. The valve body 34 of the first fuel pressure regulating valve 32 may be integrated with the component covering the through hole of the pump housing 3, and the integrated components may be fixed to the outer wall 3a of the pump housing 3. In a structure in which the first fuel pressure regulating valve 32 is separated from the cover 22, an additional mounting component may be needed for mounting the first fuel pressure regulating valve 32 on the cover 22. In contrast, in a structure in which the valve body 34 of the first fuel pressure regulating valve 32 is integrated with the cover 22, such an additional mounting component can be omitted, and a manufacturing process for mounting the first fuel pressure regulating valve 32 to the cover 22 can be also omitted. In addition, the entire structure can be simplified.

In the first embodiment, the fuel injection pump 2 includes the two pressure regulating valves including the first fuel pressure regulating valve 32 and the second fuel pressure regulating valve 33. Alternatively, the fuel injection pump 2 may include only the first fuel pressure regulating valve 32, which regulates pressure of fuel discharged from the feed pump 7.

The pump housings may be integrated with each other to be a one piece.

The above structures of the embodiments can be combined as appropriate.

Various modifications and alternations may be diversely made to the above embodiments without departing from the spirit of the present invention.

What is claimed is:

1. A fuel injection pump for an engine, the fuel injection pump comprising:
a pump housing having one side and an other side therebetween having a cam chamber, the one side and the other side respectively having one through hole and an other through hole;
a camshaft having an eccentric cam accommodated in the cam chamber, the camshaft having one end inserted in the one through hole, the camshaft having an other end inserted in the other through hole, the one end adapted to being transmitted with output power of the engine;
a plunger pump portion including a plunger movable inside a cylinder for pumping fuel in conjunction with a rotary motion of the eccentric cam;
a feed pump for supplying fuel to the plunger pump portion by being driven by the camshaft;
a first pressure regulating valve for regulating pressure of fuel discharged from the feed pump; and
a cover fixed to an outer wall of the other side of the pump housing to close the other through hole,
wherein the cover is coupled with the first pressure regulating valve such that a longitudinal direction of the first pressure regulating valve is at a predetermined angle with respect to a longitudinal direction of the camshaft.

2. The fuel injection pump according to claim 1, wherein the feed pump includes a pump case as the cover accommodating a pump element for supplying fuel by being driven by the camshaft.

3. The fuel injection pump according to claim 2, wherein the pump case has an outlet hole for discharging fuel pressurized by the pump element.

4. The fuel injection pump according to claim 2, wherein the pump case has an inlet hole for drawing fuel into the pump case.

5. The fuel injection valve according to claim 2,
wherein the first pressure regulating valve includes a valve body accommodating a valve element for controlling a fuel flow,
the pump case has a mount hole on an opposite side of the pump housing with respect to the pump element, and
the mount hole of the pump case is adapted to being inserted with the valve body of the first pressure regulating valve.

6. The fuel injection valve according to claim 2, wherein the first pressure regulating valve is integrated with a valve body accommodating a valve element for controlling a fuel flow.

7. The fuel injection pump according to claim 5,
wherein the pump case has a introduction passage for leading a part fuel discharged from the pump element to the first pressure regulating valve, and
the pump case further has a relief passage for leading fuel flowing from the first pressure regulating valve to an inlet of the pump element.

8. The fuel injection pump according to claim 1,
wherein the first pressure regulating valve includes a valve body accommodating a valve element for controlling a fuel flow, and
the valve body is integrated with the cover.

9. The fuel injection valve according to claim 1,
wherein the first pressure regulating valve includes a piston as the valve element, and
the piston is movable inside the valve body for controlling fuel quantity by varying an opening of a relief hole in a sidewall of the valve body according to pressure of fuel discharged from the feed pump.

10. The fuel injection pump according to claim 3, wherein the outlet hole extends substantially in the longitudinal direction of the camshaft.

11. The fuel injection pump according to claim 4, wherein the inlet hole extends substantially in the longitudinal direction of the camshaft.

12. The fuel injection pump according to claim 1, wherein the longitudinal direction of the first pressure regulating valve is substantially perpendicular to the longitudinal direction of the camshaft.

13. The fuel injection valve according to claim 1, further comprising:
a second pressure regulating valve for regulating pressure of fuel supplied from the feed pump to the plunger pump portion; and
an orifice throttling a fuel passage communicating the first pressure regulating valve with the second pressure regulating valve,
wherein the first pressure regulating valve is adapted to regulating pressure of fuel upstream of the orifice.

14. A fuel injection pump comprising:
a pump housing having a cam chamber;
a camshaft having an eccentric cam accommodated in the cam chamber, the camshaft having an axial end inserted in a through hole of an outer wall of the pump housing;
a plunger pump portion including a plunger for pumping fuel by being driven by the eccentric cam;
a feed pump for supplying fuel to the plunger pump portion by being driven by the camshaft; and
a pressure regulating valve for regulating pressure of fuel discharged from the feed pump,
wherein the feed pump is separately provided from the pump housing and fixed to the outer wall to close the through hole, and
the pressure regulating valve is coupled with the feed pump such that a longitudinal direction of the pressure regulating valve is inclined with respect to a longitudinal direction of the camshaft.
